(19) United States
(12) Patent Application Publication
(10) Pub. No.: US 2025/0246659 A1
(43) Pub. Date: Jul. 31, 2025

(54) MANUFACTURING METHOD FOR ELONGATED ELECTRODE LAMINATE AND MANUFACTURING DEVICE FOR ELONGATED ELECTRODE LAMINATE

(71) Applicant: HONDA MOTOR CO., LTD., Tokyo (JP)

(72) Inventors: Fumiyoshi KUROSU, Saitama (JP); Kazuki MATSUNAGA, Saitama (JP); Masahiro SHIWA, Saitama (JP)

(21) Appl. No.: 18/991,727

(22) Filed: Dec. 23, 2024

(30) Foreign Application Priority Data
Jan. 30, 2024 (JP) 2024-011920

(51) Int. Cl. H01M 8/1004

(52) U.S. Cl. CPC H01M 8/1004

(57) ABSTRACT

A manufacturing device for an elongated electrode laminate according to one embodiment of the present invention includes: a roll press that forms a base-material-equipped elongated electrode laminate by pressure-bonding an elongated catalyst film and a base-material-equipped elongated electrolyte film that is equipped with a base material, while transporting the two in the lengthwise direction; a base-material peeling roll that peels the base material of the base-material-equipped elongated electrode laminate so as to form an elongated electrode laminate; a base-material rolling-up roll that rolls up the base material peeled from the base-material-equipped elongated electrode laminate; and a base-material stripping starter that is provided on the downstream side in the transport direction of the elongated electrode laminate and situated between a first point and a second point, the first point being a position distant from a reference position.

This application is based on and claims the benefit of priority from Japanese Patent Application No. 2024-011920, filed on 30 Jan. 2024, the content of which is incorporated herein by reference.

### BACKGROUND OF THE INVENTION

### Field of the Invention

The present invention relates to a manufacturing method for an elongated electrode laminate and a manufacturing device for the elongated electrode laminate.

### Related Art

In recent years, research and development that pertains to fuel cells contributing to the enhancement of energy efficiency has been carried out in order to ensure that more people have access to reliable, sustainable, and advanced energy at reasonable cost. As a general rule, fuel cells have a membrane electrode assembly (MEA) that includes an anode-side catalyst layer and a cathode-side catalyst layer disposed in such a manner as to be opposed to each other with an electrolyte layer therebetween. As a method for continuously manufacturing the membrane electrode assembly, a method has been studied that involves, while transporting an elongated electrolyte film in the lengthwise direction, laminating a cathode-side catalyst layer onto one surface of the electrolyte film, and laminating an anode-side catalyst layer onto the other surface of the electrolyte film (see, for example, Patent Document 1).

Patent Document 1: Japanese Unexamined Patent Application, Publication No. 2020-102330

### SUMMARY OF THE INVENTION

In the meantime, for techniques pertaining to fuel cells, it is important to laminate an electrode film including an anode-side catalyst layer or a cathode-side catalyst layer onto an electrolyte film with no gap therebetween. However, laminating an electrode film onto a surface of an elongated electrolyte film while transporting the electrolyte film in the lengthwise direction could produce wrinkles in the electrolyte film or the electrode film or produce bubbles between the electrolyte film and the electrode film.

The present invention was achieved in view of the circumstances noted above, and an object thereof is to provide a method and a manufacturing device that allow for the manufacture of an elongated electrode laminate formed by laminating an elongated electrolyte film and an elongated electrode film industrially efficiently without producing wrinkles or bubbles. The present invention ultimately contributes to the improvement of energy efficiency.

The inventors completed the present invention as a result of finding that the problem described above can be solved through a process in which: an elongated electrolyte film equipped with a base material and an elongated catalyst film are pressure-bonded so as to provide an elongated electrode laminate equipped with the base material; and then, the base material is peeled using a prescribed method. Accordingly, the present invention provides the following.
(1) A manufacturing method for an elongated electrode laminate, the method including: a pressure-bonding step of forming a base-material-equipped elongated electrode laminate by pressure-bonding an elongated catalyst film and a base-material-equipped elongated electrolyte film that is equipped with a base material, while transporting the two in the lengthwise direction; a base-material peeling step of forming an elongated electrode laminate by peeling the base material by pulling the same along a base-material peeling roll disposed on the base material side of the base-material-equipped elongated electrode laminate, while transporting the base-material-equipped elongated electrode laminate in the lengthwise direction; and a base-material rolling-up step of rolling up the base material peeled from the base-material-equipped elongated electrode laminate around a base-material rolling-up roll, wherein the base-material peeling step is started using the following method.
1) A cut section is formed by cutting a portion of the base-material-equipped elongated electrode laminate in the width direction, and the base material is stripped from the base-material-equipped elongated electrode laminate with the cut section as the starting point.
2) The leading end of the stripped base material is wound on the base-material rolling-up roll.
3) The base material is rolled up by using the base-material rolling-up roll so as to pull the base material of the base-material-equipped elongated electrode laminate.

In the manufacturing method for an elongated electrode laminate according to aspect (1), when pressure-bonding the elongated catalyst film and the base-material-equipped elongated electrolyte film in the pressure-bonding step, the elongated catalyst film and the elongated electrolyte film are supported by the base material, so wrinkles or bubbles are unlikely to be produced in the base-material-equipped elongated electrode laminate to be formed. In addition, when starting the base-material peeling step, a cut section formed by cutting a portion of the base-material-equipped elongated electrode laminate in the width direction is used as a starting point, so that the base material can be easily peeled from the base-material-equipped elongated electrode laminate without cutting the base-material-equipped elongated electrode laminate entirely in the width direction. Accordingly, the manufacturing method for an elongated electrode laminate according to aspect (1) allows the elongated electrode laminate to be manufactured industrially efficiently without producing wrinkles or bubbles.
(2) The manufacturing method for an elongated electrode laminate according to aspect (1), wherein in the base-material peeling step, the base material is stripped from the base-material-equipped elongated electrode laminate at a position between a first point and a second point, the first point being a position distant from a reference position, which is the position of the base-material peeling roll, by a length corresponding to the distance from the reference position to the base-material rolling-up roll, and the second point being distant from the first point by a length corresponding to the diameter of the base-material rolling-up roll.

In the manufacturing method for an elongated electrode laminate according to aspect (2), the base material is stripped from the base-material-equipped elongated electrode laminate at the abovementioned position, so that the base material stripped from the base-material-equipped elongated electrode laminate can be wound on the base-material rolling-up roll in a short time, thereby allowing the base-material peeling step to be more easily started in a short time.
(3) A manufacturing device for an elongated electrode laminate, the manufacturing device including: a roll press that forms a base-material-equipped elongated electrode laminate by pressure-bonding an elongated catalyst film and a base-material-equipped elongated electrolyte film that is equipped with a base material, while transporting the two in the lengthwise direction; a base-material peeling roll that is disposed on the downstream side in the transport direction of the base-material-equipped elongated electrode laminate in such a manner as to be situated on the base material side of the base-material-equipped elongated electrode laminate, and peels the base material of the base-material-equipped elongated electrode laminate so as to form an elongated electrode laminate; a base-material rolling-up roll that rolls up the base material peeled from the base-material-equipped elongated electrode laminate; and a base-material stripping starter that is provided on the downstream side in the transport direction of the elongated electrode laminate and situated between a first point and a second point, the first point being a position distant from a reference position, which is the position of the base-material peeling roll, by a length corresponding to the distance from the reference position to the base-material rolling-up roll, and the second point being distant from the first point by a length corresponding to the diameter of the base-material rolling-up roll.

According to the manufacturing device for an elongated electrode laminate according to aspect (3), when pressure-bonding the elongated catalyst film and the base-material-equipped elongated electrolyte film by using the roll press, the elongated catalyst film and the elongated electrolyte film are supported by the base material, so wrinkles or bubbles are unlikely to be produced in the base-material-equipped elongated electrode laminate to be formed. In addition, the base-material stripping starter is situated at the abovementioned position, so that the base material stripped from the base-material-equipped elongated electrode laminate can be wound on the base-material rolling-up roll in a short time, thereby allowing the step of peeling the base material to be more easily started in a short time. Accordingly, the use of the manufacturing device for an elongated electrode laminate according to aspect (3) allows the elongated electrode laminate to be manufactured industrially efficiently without producing wrinkles or bubbles.
(4) The manufacturing device for an elongated electrode laminate according to aspect (3), wherein the base-material stripping starter is provided with a cutter for cutting a portion of the base material in the width direction.

The manufacturing device for an elongated electrode laminate according to aspect (4) allows the base-material stripping starter to cut the base material smoothly. Hence, the step of peeling the base material from the base-material-equipped elongated electrode laminate can be more easily started in a short time.
(5) The manufacturing device for an elongated electrode laminate according to aspect (3) or (4), wherein the base-material-equipped elongated electrode laminate is transported to the base-material peeling roll such that the base material is situated on the upper side.

The manufacturing device for an elongated electrode laminate according to aspect (5) allows the base material to be cut more smoothly. Hence, the step of peeling the base material from the base-material-equipped elongated electrode laminate can be more easily started in a short time.
(6) The manufacturing device for an elongated electrode laminate according to aspect (5), the manufacturing device further including a transport roll that is disposed between the base-material peeling roll and the base-material stripping starter in such a manner as to be situated on the lower surface side of the elongated electrode laminate.

The manufacturing device for an elongated electrode laminate according to aspect (6) stabilizes the transport of the elongated electrode laminate and allows the base material to be smoothly wound on the base-material rolling-up roll when starting the base-material peeling step.

The present invention can provide a method and a manufacturing device that allow for the manufacture of an elongated electrode laminate formed by laminating an elongated electrolyte film and an elongated electrode film industrially efficiently without producing wrinkles or bubbles.

### BRIEF DESCRIPTION OF THE DRAWINGS

FIG. 1 is a schematic diagram illustrating a manufacturing device for an elongated electrode laminate according to one embodiment of the present invention;

FIG. 2A is a cross-sectional view of an electrode film used in a manufacturing method for an elongated electrode laminate according to one embodiment of the present invention;

FIG. 2B is a cross-sectional view of a base-material-equipped elongated electrolyte film used in a manufacturing method for an elongated electrode laminate according to one embodiment of the present invention;

FIG. 2C is a cross-sectional view of a base-material-equipped elongated electrode laminate provided by a manufacturing method for an elongated electrode laminate according to one embodiment of the present invention;

FIG. 3A is a schematic diagram illustrating a method for starting the base-material peeling step of a manufacturing method for an elongated electrode laminate according to one embodiment of the present invention, the schematic diagram depicting a state in which a base material has been stripped from the base-material-equipped elongated electrode laminate;

FIG. 3B is a schematic diagram illustrating a method for starting the base-material peeling step of a manufacturing method for an elongated electrode laminate according to one embodiment of the present invention, the schematic diagram depicting a state achieved before the leading end of a base material stripped from the base-material-equipped elongated electrode laminate is wound on the base-material rolling-up roll;

FIG. 3C is a schematic diagram illustrating a method for starting the base-material peeling step of a manufacturing method for an elongated electrode laminate according to one embodiment of the present invention, the schematic diagram depicting a state achieved after the leading end of a base material stripped from the base-material-equipped elongated electrode laminate is wound on the base-material rolling-up roll;

FIG. 4A is a schematic diagram illustrating a step of stripping a base material from a base-material-equipped elongated electrode laminate in a manufacturing method for an elongated electrode laminate according to one embodiment of the present invention, the schematic diagram depicting a state in which a cut section has been formed in the base-material-equipped elongated electrode laminate;

FIG. 4B is a schematic diagram illustrating a step of stripping a base material from a base-material-equipped elongated electrode laminate in a manufacturing method for an elongated electrode laminate according to one embodiment of the present invention, the schematic diagram depicting a state in which a portion of the base material has been stripped from the cut section; and

FIG. 4C is a schematic diagram illustrating a step of stripping a base material from a base-material-equipped elongated electrode laminate in a manufacturing method for an elongated electrode laminate according to one embodiment of the present invention, the schematic diagram depicting a state in which the base material has been stripped entirely in the width direction.

### DETAILED DESCRIPTION OF THE INVENTION

By referring to the annexed drawings, the following describes a manufacturing method for an elongated electrode laminate and a manufacturing device for the elongated electrode laminate according to one embodiment of the present invention. However, the embodiments hereinafter exemplify the present invention, and the present invention is not limited to the embodiments hereinafter.

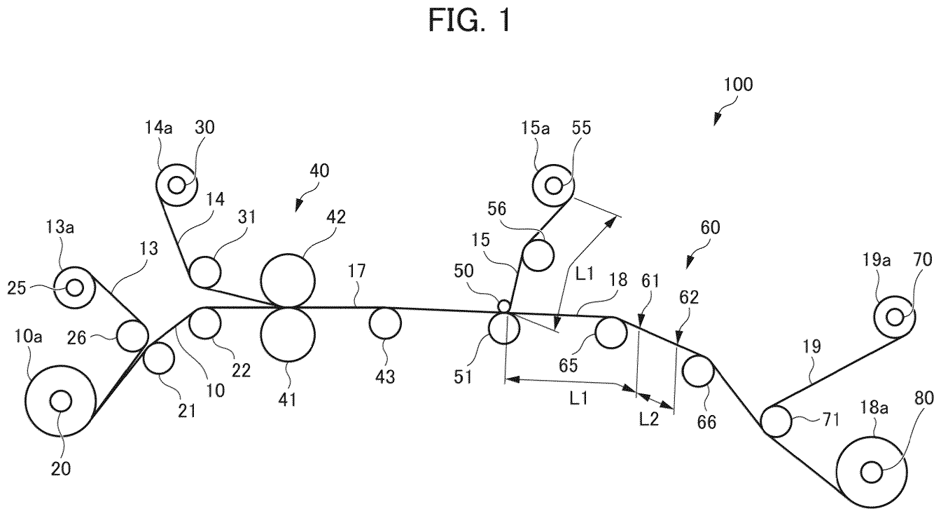

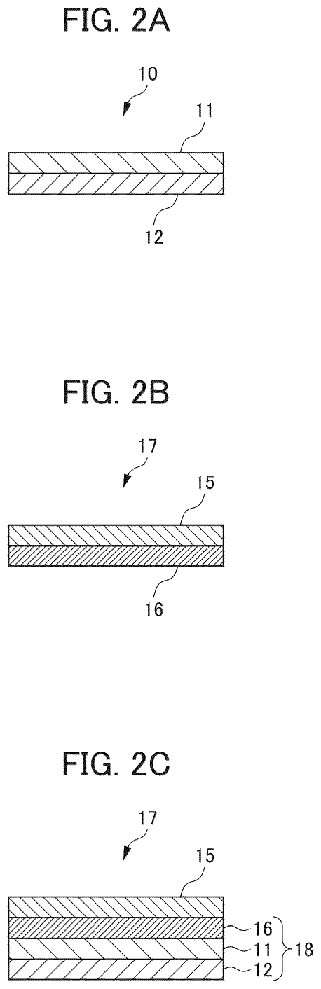

FIG. 1 is a schematic diagram illustrating a manufacturing device for an elongated electrode laminate according to one embodiment of the present invention. FIG. 2A is a cross-sectional view of an elongated catalyst film used in a manufacturing method for an elongated electrode laminate according to one embodiment of the present invention; FIG. 2B is a cross-sectional view of a base-material-equipped elongated electrolyte film used in a manufacturing method for an elongated electrode laminate according to one embodiment of the present invention. FIG. 2C is a cross-sectional view of a base-material-equipped elongated electrode laminate provided by a manufacturing method for an elongated electrode laminate according to one embodiment of the present invention.

A manufacturing device 100 depicted in FIG. 1 for an elongated electrode laminate has a catalyst film feed roll 20, a first interlayer sheet rolling-up roll 25, an electrolyte film feed roll 30, a roll press 40, a base-material peeling roll 50, a base-material rolling-up roll 55, a base-material stripping starter 60, a second interlayer sheet feed roll 70, and an elongated electrode laminate rolling-up roll 80.

A catalyst film roll 10a is disposed on the catalyst film feed roll 20. The catalyst film roll 10a is wound with an elongated catalyst film 10 being superposed on a first interlayer sheet 13. The catalyst film feed roll 20 feeds the elongated catalyst film 10 and the first interlayer sheet 13 from the catalyst film roll 10a (elongated catalyst film feed step). As depicted in FIG. 2A, the elongated catalyst film 10 is a catalyst-coated diffusion medium (CCDM) that has a cathode-side catalyst layer 11 and a gas diffusion layer 12. The elongated catalyst film 10 that has been fed is transported to the roll press 40 by a first catalyst film transport roll 21 and a second catalyst film transport roll 22.

The first interlayer sheet 13 is transported to the first interlayer sheet rolling-up roll 25 by a first interlayer sheet transport roll 26. The first interlayer sheet rolling-up roll 25 rolls up the first interlayer sheet 13, thereby forming a first interlayer sheet roll 13a.

An electrolyte film roll 14a is disposed on the electrolyte film feed roll 30. The electrolyte film feed roll 30 feeds a base-material-equipped elongated electrolyte film 14 from the electrolyte film roll 14a (base-material-equipped elongated electrolyte film feed step). As depicted in FIG. 2B, the base-material-equipped elongated electrolyte film 14 is a laminate formed by laminating a base material 15 and an electrolyte film 16 on each other. In present embodiments, the base-material-equipped elongated electrolyte film 14 is transported to the roll press 40 such that the base material 15 is situated on the upper side. An electrolyte film transport roll 31 is disposed between the electrolyte film feed roll 30 and the roll press 40.

The roll press 40 pressure-bonds the elongated catalyst film 10 and the base-material-equipped elongated electrolyte film 14 while transporting the two in the lengthwise direction, such that a base-material-equipped elongated electrode laminate 17 is formed (pressure-bonding step). The roll press 40 has a lower roll 41 and an upper roll 42. For example, the lower roll 41 and the upper roll 42 may be heat rolls formed from a metal. The lower roll 41 may also be a nip roll. In the base-material-equipped elongated electrode laminate 17, as depicted in FIG. 2C, the electrolyte film 16 and the cathode-side catalyst layer 11 of the elongated catalyst film 10 are pressure-bonded. The base-material-equipped elongated electrode laminate 17 is transported to the base-material peeling roll 50. A base-material-equipped elongated electrode laminate transport roll 43 is disposed between the roll press 40 and the base-material peeling roll 50.

The base-material peeling roll 50 is disposed on the downstream side of the roll press 40 in the transport direction of the base-material-equipped elongated electrode laminate 17 in such a manner as to be situated on the base material 15 side of the base-material-equipped elongated electrode laminate 17. The base-material peeling roll 50 extends in the width direction of the base-material-equipped elongated electrode laminate 17. The base material 15 is peeled by pulling the base material 15 along the base-material peeling roll 50 in a direction (upward in FIG. 1) differing from the transport direction of the base-material-equipped elongated electrode laminate 17 while transporting the base-material-equipped elongated electrode laminate 17 in the lengthwise direction, thereby forming an elongated electrode laminate 18 (base-material peeling step). The pull direction of the base material 15 is not particularly limited, and is adjusted in consideration of conditions such as the degree of ease of peeling the base material 15.

The base-material rolling-up roll 55 is disposed above the base-material peeling roll 50. The base material 15 peeled by the base-material peeling roll 50 is transported to the base-material rolling-up roll 55 by a base-material transport roll 56. The base-material rolling-up roll 55 rolls up the base material 15, thereby forming a base material roll 15a (base-material rolling-up step).

The base-material stripping starter 60 is used when starting to peel the base material 15 from the base-material-equipped elongated electrode laminate 17. The base-material stripping starter 60 is provided on the downstream side of the base-material peeling roll 50 in the transport direction of the elongated electrode laminate 18. The base-material stripping starter 60 is situated between a first point 61 and a second point 62, the first point 61 being a position distant from a reference position, which is the position of the base-material peeling roll 50, by a length corresponding to a distance L1 from the reference position to the base-material rolling-up roll, and the second point 62 being distant from the first point 61 by a length L2 corresponding to the diameter of the base-material rolling-up roll 55. The base-material stripping starter 60 may be provided with a cutter (not illustrated) for cutting the base material 15 of the base-material-equipped elongated electrode laminate 17 in the width direction.

A first transport roll 65 is disposed between the base-material peeling roll 50 and the base-material stripping starter 60. The first transport roll 65 is disposed on the lower surface side of the elongated electrode laminate 18. A second transport roll 66 is disposed on the downstream side of the base-material stripping starter 60 in the transport direction of the elongated electrode laminate 18. The first transport roll 65 and the second transport roll 66 are disposed in such a manner as to be in contact with the lower surface side of the elongated electrode laminate 18.

A second interlayer sheet roll 19a is disposed on the second interlayer sheet feed roll 70. A second interlayer sheet 19 fed from the second interlayer sheet roll 19a by the second interlayer sheet feed roll 70 is sent to a press roll 71. The press roll 71 superposes the elongated electrode laminate 18 and the second interlayer sheet 19 on each other. The superposed elongated electrode laminate 18 and second interlayer sheet 19 are transported to the elongated electrode laminate rolling-up roll 80.

The elongated electrode laminate rolling-up roll 80 rolls up the elongated electrode laminate 18 and the second interlayer sheet 19 in a state of being superposed on each other, thereby forming an electrode laminate roll 18a (elongated electrode laminate rolling-up step).

As a result, the elongated electrode laminate 18, in which the cathode-side catalyst layer 11 and the gas diffusion layer 12 are laminated in this order on one surface of the electrolyte film 16, is manufactured.

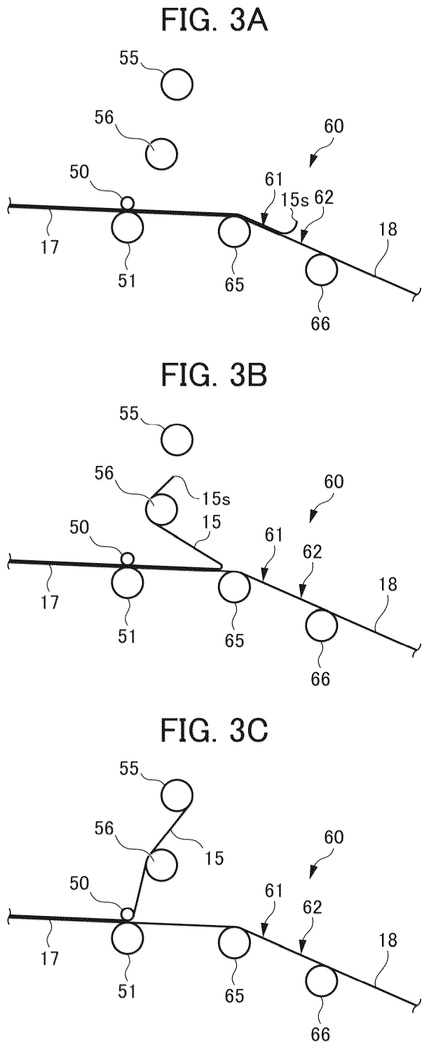

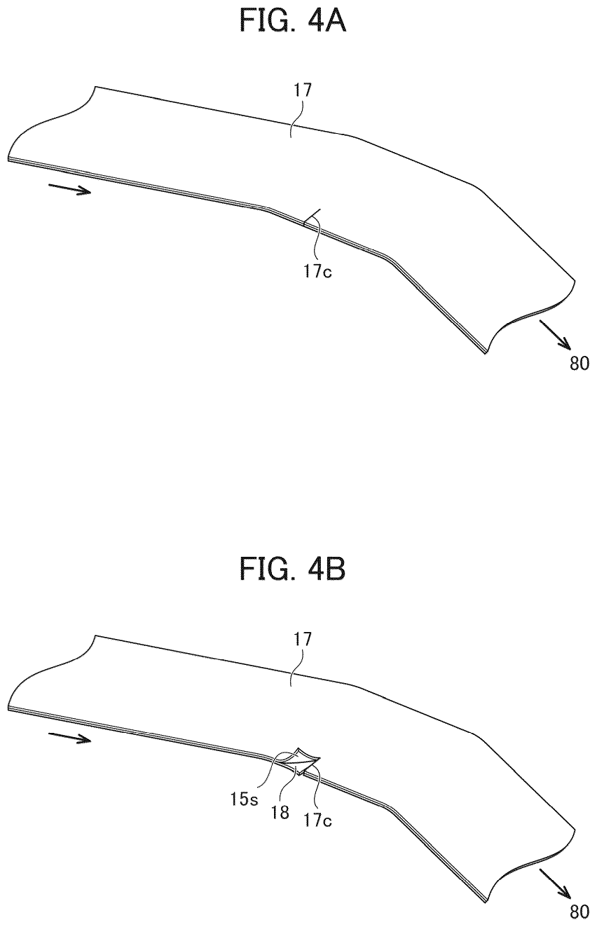

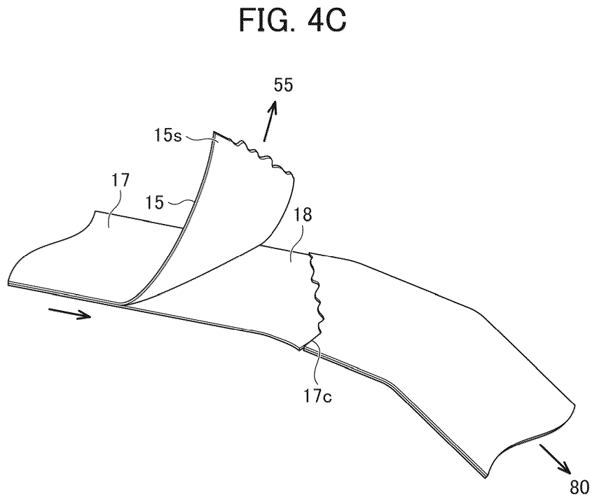

Next, descriptions are given of a method for starting the base-material peeling step by referring to FIGS. 3A to 3C and FIGS. 4A to 4C. FIGS. 3A-3C illustrate a method for starting the base-material peeling step. FIG. 3A is a schematic diagram depicting a state in which the base material has been stripped from the base-material-equipped elongated electrode laminate. FIG. 3B is a schematic diagram depicting a state achieved before the leading end of the base material stripped from the base-material-equipped elongated electrode laminate is wound on the base-material rolling-up roll. FIG. 3C is a schematic diagram depicting a state achieved after the leading end of the base material stripped from the base-material-equipped elongated electrode laminate is wound on the base-material rolling-up roll. FIGS. 4A-4C illustrate a step of stripping the base material from the base-material-equipped elongated electrode laminate. FIG. 4A is a schematic diagram depicting a state in which a cut section has been formed in the base-material-equipped elongated electrode laminate. FIG. 4B is a schematic diagram depicting a state in which a portion of the base material has been stripped from the cut section. FIG. 4C is a schematic diagram depicting a state in which the base material has been stripped entirely in the width direction.

First, as depicted in FIG. 3A, a base-material leading end 15s is stripped from the base-material-equipped elongated electrode laminate 17. The stripping of the base-material leading end 15s is performed at the base-material stripping starter 60. First, the base-material-equipped elongated electrode laminate 17 is transported to a position beyond the base-material stripping starter 60, e.g., the position of the elongated electrode laminate rolling-up roll 80. Then, as depicted in FIG. 4A, a cut section 17c is formed by cutting a portion of the base-material-equipped elongated electrode laminate 17 in the width direction. The cut section 17c may have such a length in the width direction that the base-material-equipped elongated electrode laminate 17 is not entirely cut when transported in the lengthwise direction, e.g., approximately 1/4 of the width of the base-material-equipped elongated electrode laminate 17. Subsequently, as depicted in FIG. 4B, the base-material leading end 15s at the cut section 17c is pulled upward. Afterwards, as depicted in FIG. 4C, the base-material leading end 15s is further pulled upward, thereby stripping the base material 15 of the base-material-equipped elongated electrode laminate 17 entirely in the width direction.

Next, as depicted in FIG. 3B, the base-material leading end 15s is sent through a space between the base-material peeling roll 50 and the base-material transport roll 56. Then, the base-material leading end 15s is wound on the base-material rolling-up roll 55.

Afterwards, as depicted in FIG. 3C, the base material 15 is rolled up by rotating the base-material rolling-up roll 55. As a result, the peeling position for the base material 15 is moved to the base-material peeling roll 50, and the base material 15 of the base-material-equipped elongated electrode laminate 17 is pulled along the base-material peeling roll 50 in a direction differing from the transport direction of the base-material-equipped elongated electrode laminate 17, thereby continuously stripping the base material 15.

According to the manufacturing method for an elongated electrode laminate according to present embodiments provided with features such as those noted above, when pressure-bonding the elongated catalyst film 10 and the base-material-equipped elongated electrolyte film 14 in the pressure-bonding step, the elongated catalyst film 10 and the elongated electrolyte film 14 are supported by the base material 15, so wrinkles or bubbles are unlikely to be produced in the base-material-equipped elongated electrode laminate 17 to be formed. In addition, when starting the base-material peeling step, a cut section 17c formed by cutting a portion of the base-material-equipped elongated electrode laminate 17 in the width direction is used as a starting point, so that the base material can be easily peeled from the base-material-equipped elongated electrode laminate 17 without cutting the base-material-equipped elongated electrode laminate 17 entirely in the width direction. Furthermore, when the base material 15 is stripped at the base-material stripping starter 60 from the base-material-equipped elongated electrode laminate 17 for which the base-material peeling step starts, the base material 15 stripped from the base-material-equipped elongated electrode laminate 17 can be wound on the base-material rolling-up roll 55 in a short time, thereby allowing the base-material peeling step to be more easily started in a short time. Accordingly, the manufacturing method for an elongated electrode laminate according to present embodiments allows the elongated electrode laminate 18 to be manufactured industrially efficiently without producing wrinkles or bubbles.

According to the manufacturing device 100 for an elongated electrode laminate according to present embodiments, when pressure-bonding the elongated catalyst film 10 and the base-material-equipped elongated electrolyte film 14 by using the roll press 40, the elongated catalyst film 10 and the elongated electrolyte film 14 are supported by the base material 15, so wrinkles or bubbles are unlikely to be produced in the base-material-equipped elongated electrode laminate 17 to be formed. In addition, the base-material stripping starter 60 is situated at the abovementioned position, so that the step of peeling the base material 15 from the base-material-equipped elongated electrode laminate 17 can be easily started in a short time. Accordingly, the use of the manufacturing device 100 for an elongated electrode laminate according to present embodiments allows the elongated electrode laminate 18 to be manufactured industrially efficiently without producing wrinkles or bubbles.

According to the manufacturing device 100 for an elongated electrode laminate according to present embodiments, when the base-material stripping starter 60 is provided with a cutter for cutting the base material 15 in the width direction, the base-material stripping starter 60 can smoothly cut the base material 15. Hence, the step of peeling the base material 15 from the base-material-equipped elongated electrode laminate 17 can be more easily started in a short time.

According to the manufacturing device 100 for an elongated electrode laminate according to present embodiments, the base material 15 is more smoothly cut when the base-material-equipped elongated electrode laminate 17 is transported to the base-material peeling roll 50 such that the base material 15 is situated on the upper side. Hence, the step of peeling the base material 15 from the base-material-equipped elongated electrode laminate 17 can be more easily started in a short time.

According to the manufacturing device 100 for an elongated electrode laminate according to present embodiments, when a first transport roll 65 is provided that is disposed between the base-material peeling roll 50 and the base-material stripping starter 60 in such a manner as to be situated on the lower surface side of the elongated electrode laminate 18, the transport of the elongated electrode laminate 18 is stabilized, and the base-material leading end 15s can be smoothly wound on the base-material rolling-up roll 55 when starting the base-material peeling step.

Embodiments of the present invention have been described so far, but the present invention is not limited to the embodiments described above.

In present embodiments, the elongated catalyst film 10 is a laminate formed by laminating the cathode-side catalyst layer 11 and the gas diffusion layer 12. However, the configuration of the elongated catalyst film 10 is not limited to this. For example, the elongated catalyst film 10 may be a single-layer body constituted by the cathode-side catalyst layer 11. Alternatively, the elongated catalyst film 10 may be a single-layer body constituted by an anode-side catalyst layer, or may be a laminate formed by laminating an anode-side catalyst layer and a gas diffusion layer.

In present embodiments, the elongated electrode laminate 18 is formed in the shape of a roll. However, before the elongated electrode laminate 18 is formed in the shape of a roll, an anode-side catalyst layer may be laminated on the surface of the electrolyte film 16 on the opposite side from the cathode-side catalyst layer 11.

### EXPLANATION OF REFERENCE NUMERALS

10: Elongated catalyst film
10a: Catalyst film roll
11: Cathode-side catalyst layer
12: Gas diffusion layer
13: First interlayer sheet
13a: First interlayer sheet roll
14: Base-material-equipped elongated electrolyte film
14a: Electrolyte film roll
15: Base material
15a: Base material roll
15s: Base-material leading end
16: Electrolyte film
17: Base-material-equipped elongated electrode laminate
18: Elongated electrode laminate
18a: Electrode laminate roll
19: Second interlayer sheet
19a: Second interlayer sheet roll
20: Catalyst film feed roll
21: First catalyst film transport roll
22: Second catalyst film transport roll
25: First interlayer sheet rolling-up roll
26: First interlayer sheet transport roll
30: Electrolyte film feed roll
31: Electrolyte film transport roll
40: Roll press
41: Lower roll
42: Upper roll
43: Base-material-equipped elongated electrode laminate transport roll
50: Base-material peeling roll
51: Elongated electrode laminate transport roll
55: Base-material rolling-up roll
56: Base-material transport roll
60: Base-material stripping starter
61: First point
62: Second point
65: First transport roll
66: Second transport roll
70: Second interlayer sheet feed roll
71: Press roll
80: Elongated electrode laminate rolling-up roll

What is claimed is:

1. A manufacturing method for an elongated electrode laminate, the manufacturing method comprising:
a pressure-bonding step of forming a base-material-equipped elongated electrode laminate by pressure-bonding an elongated catalyst film and a base-material-equipped elongated electrolyte film that is equipped with a base material, while transporting the two in a lengthwise direction;
a base-material peeling step of forming an elongated electrode laminate by peeling the base material by pulling the same along a base-material peeling roll disposed on a base material side of the base-material-equipped elongated electrode laminate, while transporting the base-material-equipped elongated electrode laminate in the lengthwise direction; and
a base-material rolling-up step of rolling up the base material peeled from the base-material-equipped elongated electrode laminate around a base-material rolling-up roll, wherein
the base-material peeling step is started using the following method including:
1) forming a cut section by cutting a portion of the base-material-equipped elongated electrode laminate in a width direction, and stripping the base material from the base-material-equipped elongated electrode laminate with the cut section as a starting point,
2) winding a leading end of the stripped base material on the base-material rolling-up roll, and
3) rolling up the base material up by using the base-material rolling-up roll so as to pull the base material of the base-material-equipped elongated electrode laminate.

2. The manufacturing method for an elongated electrode laminate according to claim 1, wherein
in the base-material peeling step, the base material is stripped from the base-material-equipped elongated electrode laminate at a position between a first point and a second point, the first point being a position distant from a reference position, which is a position of the base-material peeling roll, by a length corresponding to a distance from the reference position to the base-material rolling-up roll, and the second point being distant from the first point by a length corresponding to a diameter of the base-material rolling-up roll.

3. A manufacturing device for an elongated electrode laminate, the manufacturing device comprising:
a roll press that forms a base-material-equipped elongated electrode laminate by pressure-bonding an elongated catalyst film and a base-material-equipped elongated electrolyte film that is equipped with a base material, while transporting the two in a lengthwise direction;
a base-material peeling roll that is disposed on a downstream side in a transport direction of the base-material-equipped elongated electrode laminate in such a manner as to be situated on a base material side of the base-material-equipped elongated electrode laminate, and forms an elongated electrode laminate by peeling the base material of the base-material-equipped elongated electrode laminate;
a base-material rolling-up roll that rolls up the base material peeled from the base-material-equipped elongated electrode laminate; and
a base-material stripping starter that is provided on the downstream side in the transport direction of the elongated electrode laminate and is situated between a first point and a second point, the first point being a position distant from a reference position, which is a position of the base-material peeling roll, by a length corresponding to a distance from the reference position to the base-material rolling-up roll, and the second point being distant from the first point by a length corresponding to a diameter of the base-material rolling-up roll.

4. The manufacturing device for an elongated electrode laminate according to claim 3, wherein
the base-material stripping starter is provided with a cutter for cutting a portion of the base material in a width direction.

5. The manufacturing device for an elongated electrode laminate according to claim 3, wherein
the base-material-equipped elongated electrode laminate is transported to the base-material peeling roll such that the base material is situated on an upper side.

6. The manufacturing device for an elongated electrode laminate according to claim 5, the manufacturing device further comprising:
a transport roll that is disposed between the base-material peeling roll and the base-material stripping starter in such a manner as to be situated on a lower surface side of the elongated electrode laminate.
